(19) United States
(12) Patent Application Publication
(10) Pub. No.: US 2025/0386370 A1
(43) Pub. Date: Dec. 18, 2025

(54) ENHANCED DISTRIBUTED CHANNEL ACCESS (EDCA) RULES WITHIN COORDINATED RESTRICTED TARGET WAKE-UP TIME (CRTWT) SERVICE PERIODS

(71) Applicant: QUALCOMM Incorporated, San Diego, CA (US)

(72) Inventors: Giovanni CHISCI, San Diego, CA (US); Abhishek Pramod PATIL, San Diego, CA (US); Alfred ASTERJADHI, San Diego, CA (US); Sherief HELWA, San Diego, CA (US); George CHERIAN, San Diego, CA (US); Sanket Sanjay KALAMKAR, San Diego, CA (US); Sai Yiu Duncan HO, San Diego, CA (US); Gaurang NAIK, San Diego, CA (US)

(21) Appl. No.: 18/745,952

(22) Filed: Jun. 17, 2024

(51) Int. Cl. H04W 74/0816; H04W 72/0446; H04W 74/08

(52) U.S. Cl. CPC H04W 74/0816; H04W 72/0446; H04W 74/0875

(57) ABSTRACT

This disclosure provides methods, components, devices and systems for EDCA rules within CrTWT service periods. Some aspects more specifically relate to defining EDCA rules for channel access during a coordinated time region. In some examples, a wireless device may obtain a message indicating a coordinated time region associated with a first access point (AP). The message may request prioritized access for the first AP to a shared wireless channel during the coordinated time region. The wireless device may perform a channel access procedure for the shared wireless channel over a time duration that occurs within the coordinated time region. A length of the time duration is extended based at least in part on the channel access procedure being performed within the coordinated time region.

### TECHNICAL FIELD

This disclosure relates generally to wireless communication and, more specifically, to enhanced distributed channel access (EDCA) rules within coordinated restricted targeted wake-up time (CrTWT) service periods.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

A method by a wireless device is described. The method may include obtaining a first message indicating a coordinated time region associated with a first access point (AP), the first message requesting prioritized access for the first AP to a shared wireless channel during the coordinated time region and performing a channel access procedure for the shared wireless channel over a time duration that occurs within the coordinated time region, where a length of the time duration may be extended based on the channel access procedure being performed within the coordinated time region.

A wireless device is described. The wireless device may include a processing system that includes processor circuitry and memory circuitry that stores code. The processing system may be configured to cause the wireless device to obtain a first message indicating a coordinated time region associated with a first AP, the first message requesting prioritized access for the first AP to a shared wireless channel during the coordinated time region and perform a channel access procedure for the shared wireless channel over a time duration that occurs within the coordinated time region, where a length of the time duration may be extended based on the channel access procedure being performed within the coordinated time region.

Another wireless device is described. The wireless device may include means for obtaining a first message indicating a coordinated time region associated with a first AP, the first message requesting prioritized access for the first AP to a shared wireless channel during the coordinated time region and means for performing a channel access procedure for the shared wireless channel over a time duration that occurs within the coordinated time region, where a length of the time duration may be extended based on the channel access procedure being performed within the coordinated time region

A non-transitory computer-readable medium storing code is described. The code may include instructions executable by one or more processors to obtain a first message indicating a coordinated time region associated with a first AP, the first message requesting prioritized access for the first AP to a shared wireless channel during the coordinated time region and perform a channel access procedure for the shared wireless channel over a time duration that occurs within the coordinated time region, where a length of the time duration may be extended based on the channel access procedure being performed within the coordinated time region.

Some examples of the method, wireless devices, and non-transitory computer-readable medium described herein may further include operations, features, means, or instructions for terminating a transmission opportunity (TXOP) prior to a start time of the coordinated time region, where the channel access procedure may be initiated at or after the start time of the coordinated time region.

In some examples of the method, wireless devices, and non-transitory computer-readable medium described herein, the length of the time duration may be extended based on terminating the TXOP prior to a start time of the coordinated time region.

In some examples of the method, wireless devices, and non-transitory computer-readable medium described herein, performing the channel access procedure may include operations, features, means, or instructions for initiating the channel access procedure prior to a start time of the coordinated time region, where the channel access procedure may be paused or terminated at or before the start time of the coordinated time region.

In some examples of the method, wireless devices, and non-transitory computer-readable medium described herein, the length of the time duration may be extended based on initiating the channel access procedure prior to the start time of the coordinated time region.

In some examples of the method, wireless devices, and non-transitory computer-readable medium described herein, performing the channel access procedure may include operations, features, means, or instructions for initiating the channel access procedure prior a start time of the coordinated time region, where the channel access procedure may be restarted at or after the start time of the coordinated time region.

In some examples of the method, wireless devices, and non-transitory computer-readable medium described herein, performing the channel access procedure may include operations, features, means, or instructions for performing the channel access procedure over the length of the time duration based on the channel access procedure being initiated within a threshold time window after a start time of the coordinated time region.

In some examples of the method, wireless devices, and non-transitory computer-readable medium described herein, performing the channel access procedure may include operations, features, means, or instructions for performing the channel access procedure over the length of the time duration based on a quantity of channel access procedures performed after a start time of the coordinated time region being less than a threshold quantity. In some examples of the method, wireless devices, and non-transitory computer-readable medium described herein, performing the channel access procedure may include operations, features, means, or instructions for monitoring the shared wireless channel for channel idle conditions for the length of the time duration that is extended based at least in part on the channel access procedure being performed within the coordinated time region.

In some examples of the method, wireless devices, and non-transitory computer-readable medium described herein, the time duration may include an inter frame space, an additional time interval for monitoring the shared wireless channel for channel idle conditions, or both.

In some examples of the method, wireless devices, and non-transitory computer-readable medium described herein, the inter frame space may be based on a delay associated with an access category (AC).

In some examples of the method, wireless devices, and non-transitory computer-readable medium described herein, the inter frame space may be based on a channel access parameter, a delay associated with an AC of traffic, or both.

In some examples of the method, wireless devices, and non-transitory computer-readable medium described herein, the additional time interval may be based on an AC associated with the wireless device.

In some examples of the method, wireless devices, and non-transitory computer-readable medium described herein, the additional time interval may be a predefined time duration.

In some examples of the method, wireless devices, and non-transitory computer-readable medium described herein, the additional time interval may be associated with a number of backoff slots.

In some examples of the method, wireless devices, and non-transitory computer-readable medium described herein, the additional time interval may be based on an AC associated with a traffic identifier (TID) flow of the first AP.

Some examples of the method, wireless devices, and non-transitory computer-readable medium described herein may further include operations, features, means, or instructions for obtaining a second message, via broadcast target wake time (TWT) signaling, indicating the AC associated with the TID flow.

In some examples of the method, wireless devices, and non-transitory computer-readable medium described herein, the first message indicates the AC associated with the TID flow.

In some examples of the method, wireless devices, and non-transitory computer-readable medium described herein, the coordinated time region may be a coordinated restricted TWT (CrTWT) period.

In some examples of the method, wireless devices, and non-transitory computer-readable medium described herein, the wireless device may be a second AP that coordinates with the first AP.

Some examples of the method, wireless devices, and non-transitory computer-readable medium described herein may further include operations, features, means, or instructions for managing traffic, at the second AP, via a multi-user enhanced distributed channel access or a request to send enablement.

In some examples of the method, wireless devices, and non-transitory computer-readable medium described herein, the wireless device may be associated with the first AP or a second AP that coordinates with the first AP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a frequency diagram depicting an example distributed tone mapping.

FIG. 6 shows an example of a signaling diagram that supports enhanced distributed channel access (EDCA) rules within CrTWT service periods.

FIG. 7A shows an example of a communications timeline that supports EDCA rules within CrTWT service periods.

FIG. 7B shows an example of a communications timeline that supports EDCA rules within CrTWT service periods.

FIG. 7C shows an example of a communications timeline that supports EDCA rules within CrTWT service periods.

FIG. 8A shows an example of a communications timeline that supports EDCA rules within CrTWT service periods.

FIG. 8B shows an example of a communications timeline that supports EDCA rules within CrTWT service periods.

FIG. 9 shows an example of a process flow that supports EDCA rules within CrTWT service periods.

FIG. 10 shows a block diagram of an example wireless communication device that supports EDCA rules within CrTWT service periods.

FIG. 11 shows a flowchart illustrating an example process performable by or at a wireless device that supports EDCA rules within CrTWT service periods.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a first wireless device (such as a first access point (AP)) may configure a coordinated time region. The coordinated time region may request prioritized access for the first wireless device to a shared wireless channel during the coordinated time region. For example, the first wireless device may transmit an announcement to one or more wireless devices (such as wireless stations (STA) or one or more additional APs). The one or more wireless devices may determine to observe the coordinated timed region. In some examples, the first wireless device may transmit a set of enhanced distributed channel access (EDCA) parameters to the one or more wireless devices to be used by the wireless devices during the coordinated time region. The EDCA parameters may delay a channel access procedure at the one or more wireless devices during the coordinated time region compared to the first wireless device. The delay at the one or more wireless devices may prioritize latency sensitive traffic associated with the first wireless device. The first wireless device may store and manage multiple sets of EDCA parameters from the one or more wireless device. Storing and managing the multiple sets of EDCA parameters may be associated with a high overhead at the first wireless device.

Various aspects relate generally to coordination between multiple wireless device (such as APs) during a coordinated time region. Some aspects more specifically relate to defining EDCA rules to reduce overhead at the first wireless device. In some examples, a second wireless device may receive a control message from the first wireless device. The control message may indicate a coordinated time region associated with the first wireless device. The second wireless device may perform a channel access procedure for the shared wireless channel over a time duration within the coordinated time region. The second wireless device may perform the channel access procedure in accordance with EDCA rules. In some examples, a length of the time duration may be extended based on the channel access procedure being performed within the coordinated time region. For example, the time duration may include an inter frame space (IFS) or additional time interval (such as an offset) based on the channel access procedure being performed within the coordinated time region. The length of the time duration may delay the channel access procedure associated with the second wireless device compared to the first wireless device. The delay at the second wireless device (such as the second time duration) may prioritize the latency sensitive traffic associated with the first wireless device. The first wireless device may not transmit a set of EDCA parameters, and the first wireless device may not store or manage the set of EDCA parameters. The lack of a set of EDCA parameters may decrease overhead associated with the coordinated timed region and increase efficient use of communication resources.

Particular aspects of the subject matter described in this disclosure can be implemented to realize one or more of the following potential advantages. In some examples, by configuring EDCA rules for the second wireless device, the described techniques can be used reduce an overhead associated with configuring a coordinated time region associated with the first wireless device. The second wireless device may perform a channel access procedure within a coordinated time region for a time duration. A length of the time duration may be extended based on performing the channel access procedure within the coordinated time region and may be configured in accordance with the EDCA rules. For example, the EDCA rules may increase efficient use of communication resources by configuring the EDCA rules for one or more coordinated time regions.

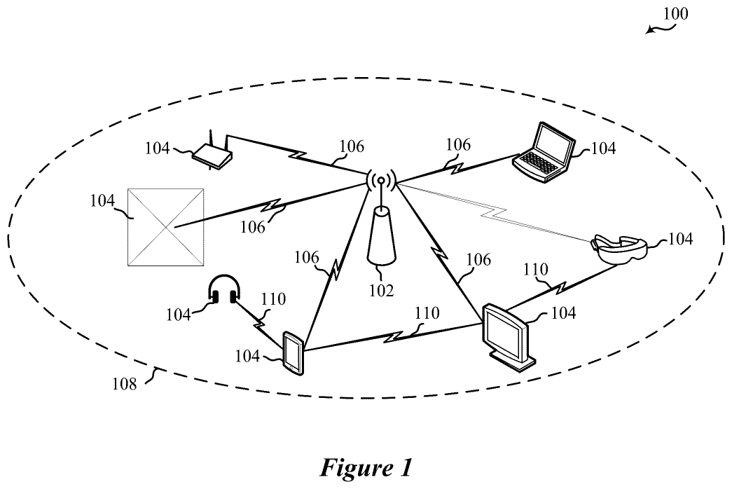

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

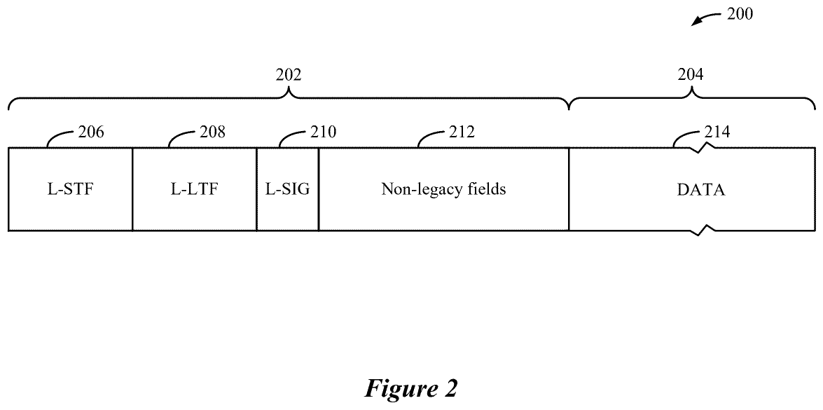

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

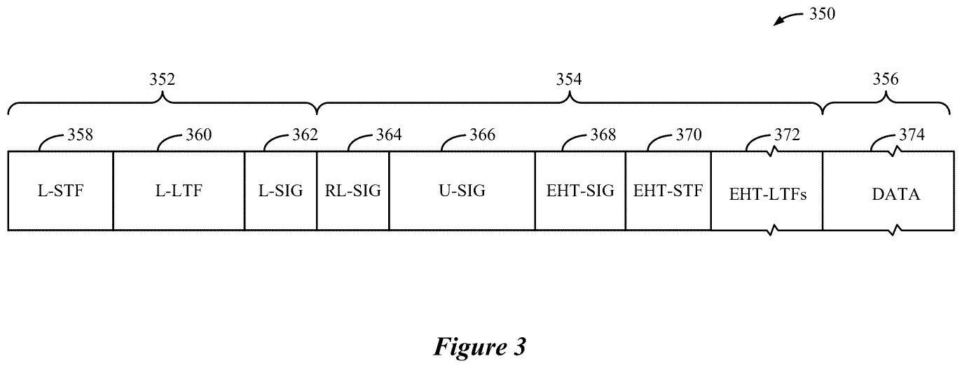

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

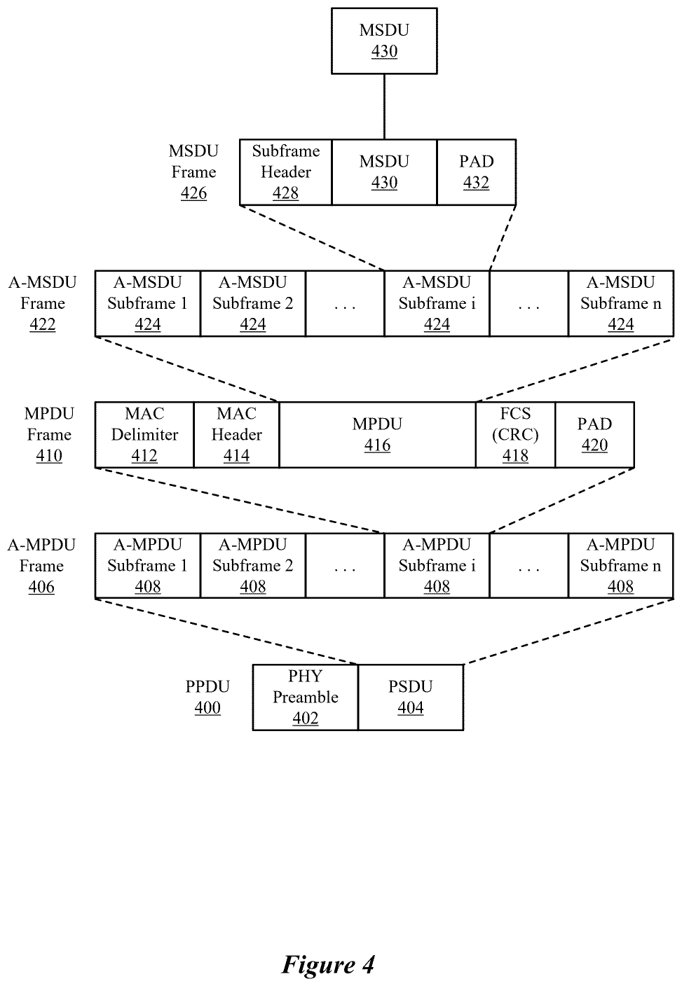

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

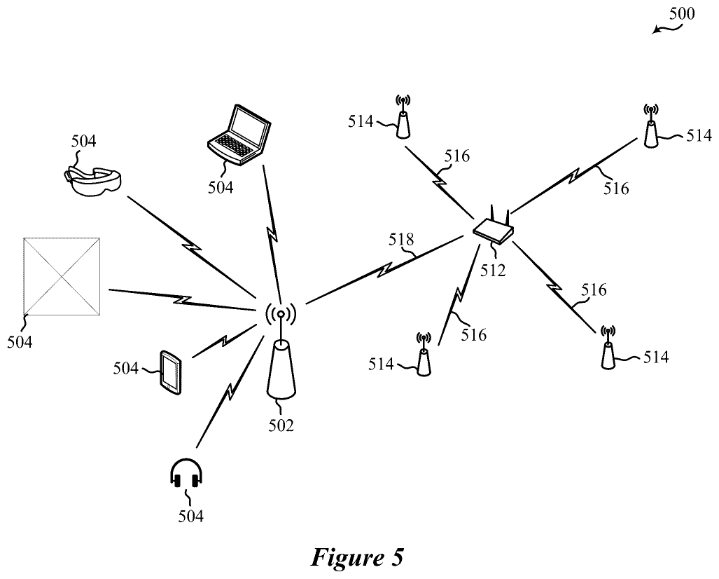

FIG. 5 shows a pictorial diagram of another example wireless communication network 500. According to some aspects, the wireless communication network 500 can be an example of a mesh network, an IoT network, or a sensor network in accordance with one or more of the IEEE 802.11 family of wireless communication protocol standards (including the 802.11ah amendment). The wireless communication network 500 may include multiple wireless communication devices 514, which in some implementations may include APs 502, STAs 504, or both. The wireless communication devices 514 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 514 sense, measure, collect or otherwise obtain and process data and transmit such raw or processed data to an intermediate device 512 for subsequent processing or distribution. Additionally, or alternatively, the intermediate device 512 may transmit control information, digital content (such as audio or video data), configuration information or other instructions to the wireless communication devices 514. The intermediate device 512 and the wireless communication devices 514 can communicate with one another via wireless communication links 516. In some examples, the wireless communication links 516 include Bluetooth links or other PAN or short-range communication links.

In some examples, the intermediate device 512 also may be configured for wireless communication with other networks such as with a WLAN or a wireless (such as cellular) wide area network (WWAN), which may, in turn, provide access to external networks including the Internet. For example, the intermediate device 512 may associate and communicate, over a Wi-Fi link 518, with an AP 102 of a wireless communication network 500, which also may serve various STAs 104. In some examples, the intermediate device 512 is an example of a network gateway, for example, an IoT gateway. In such a manner, the intermediate device 512 may serve as an edge network bridge providing a Wi-Fi core backhaul for the IoT network including the wireless communication devices 514. In some examples, the intermediate device 512 can analyze, preprocess and aggregate data received from the wireless communication devices 514 locally at the edge before transmitting it to other devices or external networks via the Wi-Fi link 518. The intermediate device 512 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as AP 102s and STA 104s) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

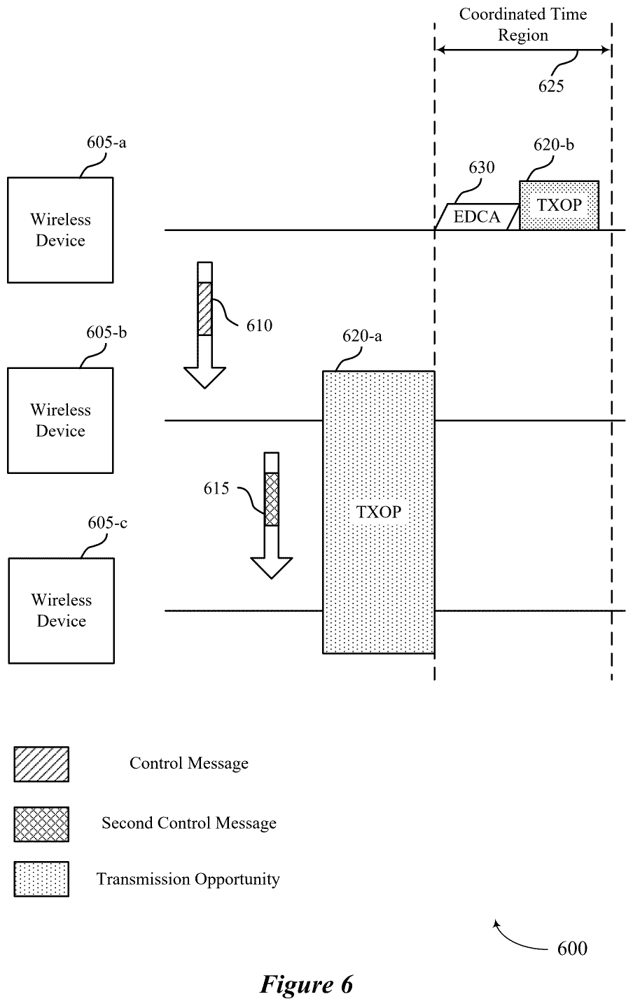

FIG. 6 shows an example of a signaling diagram 600 that supports EDCA rules within a coordinated restricted TWT (CrTWT) service periods. In some examples, signaling diagram 600 may implement aspects of wireless communication network 100. For example, a wireless device 605-a may represent an example of an AP, such as the AP 102 described with reference to FIG. 1. A wireless device 605-b may represent an example of an AP or an STA, such as the AP 102 or the STA 104 described with reference to FIG. 1.

In some wireless communications systems, the wireless device 605-b (such as an AP) may communicate with a wireless device 605-c (such as a STA). The wireless device 605-c may communicate with the wireless device 605-b in accordance with channel access rules (such as enhanced distributed channel access (EDCA) rules). An AP may configure a target wake-up time (TWT) to reduce power consumption at an AP. The AP may configure a restricted TWT (such as rTWT) to prioritize latency sensitive traffic. For example, during a time period within the rTWT, latency sensitive traffic may be prioritized over less latency sensitive traffic.

In some implementations, the wireless device 605-a (such as a coordinating AP) may configure a coordinated time region 625 (such as a CrTWT or one or more coordinated listening instances (CLIs)). The wireless device 605-a may transmit a control message 610 to configure a coordinated time region 625 across multiple APs. For example, the wireless device 605-a may configure a coordinated time region 625 based on traffic or a traffic configuration (such as traffic requirements) associated with one or more STAs served by the wireless device 605-a to secure channel access for the one or more STAs during the coordinated time region 625.

The wireless device 605-a (such as a coordinating AP) may configure the coordinated time region 625 based on low-latency communications associated with the one or more STAs. One or more additional APs in a threshold distance proximity may coordinate for obtaining prioritized channel access at the one or more STAs at some well-known coordinated times. For example, the wireless device 605-a (such as the coordinating AP) may transmit a control message 610 to the wireless device 605-b (such as an additional AP) to configure a coordinated time region 625 to prioritize one or more STAs associated with latency sensitive traffic. During the coordinated time region 625, the wireless device 605-b may prioritize the latency sensitive traffic. For example, the wireless device 605-a may have priority over channel access as compared to other APs (such as the wireless device 605-b) and non-AP STAs (such as the wireless device 605-c) associated with the wireless device 605-a or other APs.

In some implementation, the coordinated time region 625 may be an example of a CrTWT. The CrTWT may improve a capability of the wireless device 605-a to serve latency sensitive traffic. During the CrTWT, the coordinated wireless devices 605 (such as the APs engaging in the CrTWT) may respect a service period (such as a CrTWT service period) of the wireless device 605-a. A channel associated with the coordinated time region may be idle for wireless device 605-a to perform EDCA 630 at the beginning of the CrTWT service period. The EDCA 630 may be associated with a random counter indicating a quantity of observation slots. The wireless device 605-a may detect channel conditions during the observation slots, and if the channel conditions are idle during the observation slots, the wireless device may secure the channel.

The wireless device 605-a and wireless device 605-b may negotiate the coordination. For example, the wireless device 605-a and the wireless device 605-b may communicate to determine a time duration or location in time for the coordinated time region 625.

The wireless device 605-a may announce a CrTWT service period (such as a coordinated time region 625) schedule (such as the wireless device 605-a may act as a beacon). For example, the wireless device 605-a may transmit a control message 610 to the wireless device 605-b to indicate a configuration for the coordinated time region 625. In some implementations, the wireless device 605-a may transmit the control message 610 to indicate the configuration to configure the wireless device 605-b with EDCA rules for the coordinated time region 625. The EDCA rules may prioritize latency sensitive traffic associated with the wireless device 605-a by delaying other traffic associated with the wireless device 605-b.

For example, the wireless device 605-a (such as the coordinating AP) may transmit a control message 610 indicating the coordinated time region 625 to the wireless device 605-b (such as an additional AP). The wireless device 605-b may determine to respect (such as communicate in accordance with) the coordinated time region 625. The wireless device 605-b may propagate the control message 610 via a second control message 615 to one or more STAs served by the wireless device 605-b (such as the wireless device 605-c). For example, the wireless device 605-b may propagate the CrTWT protection (such as the wireless device 605-b may setup an extremely high throughput (EHT) rTWT with one or more STAs or clients so that the CrTWT SP of wireless device 605-a is protected).

The wireless device 605-b and the wireless device 605-c may communicate via a TXOP 620-a prior to the coordinated time region 625. Prior to the coordinated time region 625 or at the start of the coordinated time region 625, the wireless device 605-b and the wireless device 605-c may terminate the TXOP 620-a. For example, the wireless device 605-b may terminates the TXOP 620-b such that the TXOP 620-a does not exceed or overlap with the CrTWT service period boundary. The channel associated with the coordinated time region 625 may be free or without contention for the wireless device 605-a to perform EDCA 630 based on the coordinated time region 625. The wireless device 605-a may detect a channel idle time for a threshold duration, and the wireless device 605-a may communicate latency sensitive traffic with one or more STAs during a TXOP 620-b.

In some implementations, the wireless device 605 may enable wireless devices 605 (such as APs) operating on the same channel to coordinate respective rTWT schedules or to ensure that a first wireless device 605 may extend protection of the rTWT schedule of a second wireless device 605. For example, the wireless device 605-b may respect and extend protection for the wireless device 605-a, as illustrated in FIG. 6. If the first wireless device 605 extends the protection of the rTWT schedule of the second wireless device 605, via negotiation or through other communication, the first wireless device 605 may end a TXOP 620 prior to the start time of a corresponding overlapping basic service sets (OBSS) associated with one or more rTWT service periods. Additionally, or alternatively, the second wireless device may transmit the OBSS rTWT schedule via beacon frames. The wireless device 605-b may advertise via beacon frames such that an associated STAs supporting rTWT may follow baseline rTWT rules during the OBSS rTWT schedule.

In some implementations, the coordinated time region may be an example of a CLI. In some implementations, the wireless devices 605 may support CrTWT, CLI, or both (such as CLI may be an alternative or complement to CrTWT). The wireless device 605-a may coordinate or negotiate with the wireless device 605-b and provide time instances. The time instance may provide hooks for further inter-AP or further wireless device 605 coordination. For example, the wireless devices 605 may exchange frame for coordinated time division multiple access (C-TDMA), coordinated spatial reuse (C-SR), or coordinated beamforming (C-BF). The coordination may enable the wireless device 605-b to interrupt an ongoing TXOP 620 such that a transmission associated with the ongoing TXOP 620 may not cross the CLI (such as does not overlap the CLI). CLI may be used to obtain channel access prioritization for a wireless device 605-a (such as a coordinating AP) at some time instances (such as a coordinated time region 625).

One or more coordinated time regions 625 may encompass (such as implement aspects of) the concepts of CrTWT service periods, CLIs, or both. A coordinated time region 625 may be defined at least by a time (such as a start time of the region) and may be delimited by either an event (such as transmission from the wireless device 605-a or the wireless device 605-b) or a duration parameter. In some examples, a CrTWT may a specific example of a coordinated time region 625 defined through a broadcast TWT element indicating one or more service periods. In some examples, a CLI may provide a start of the coordinated time region.

In some examples, during a CrTWT, the wireless device 605-b may interrupt the TXOP 620-a before the CrTWT (such as coordinated time region 625) of the wireless device 605-a such that a channel associated with the coordinated time region 625 is free for the wireless device 605-a to perform EDCA. To provide further prioritization to the wireless device 605-a for EDCA during the service period configured by the wireless device 605-a, the wireless device 605-a may indicate a set of EDCA parameters (such as EDCA parameters selected by the wireless device 605-a) for the wireless device 605-b. The wireless device 605-b may utilize the set of EDCA parameters during the service period configured by the wireless device 605-a. For example, the wireless device 605-a may provide disadvantageous EDCA parameters to the wireless device 605-b. For example, the wireless device 605-a may provide the wireless device 605-a with the set of EDCA parameters associated with an increased delay. The set of EDCA parameters may configure the wireless device to detect a longer channel idle time during EDCA.

The wireless device 605-a may signal the set of EDCA parameters to the wireless device 605-b to be used in the coordinated time region 625. In some implementations, storing and configuring multiple EDCA parameters for multiple coordinated wireless devices 605 may be demanding or challenging for the wireless device 605-a to keep track of all the set of parameters from all the coordinated wireless devices 605. For example, the wireless device 605-a may configure, transmit, and store the set of EDCA parameters for a first wireless device 605 (such as AP1′), a second wireless device 605 (such as AP1″), and a third wireless device (such as AP1′″). The multiple the set of EDCA parameters may be associated with a relatively high overhead at the wireless device 605-a.

According to techniques described herein, one or more wireless devices 605 may communicate in accordance with EDCA rules during a coordinated time region. The EDCA rules may include enhancements for the one or more wireless devices (such as STAs that respect the coordinated time region 625) while entering the coordinated time region 625. The EDCA rules may achieve prioritization of the wireless device 605-a (such as coordinating AP) for low latency and fairness in the system. The EDCA rules may provide prioritization of the wireless device 605-a without the wireless device 605-a configuring, transmitting, and storing the set of EDCA parameters. The EDCA rules may reduce overhead at the wireless device 605-a. For example, a length of a time duration associated with a first channel access procedure performed at the wireless device 605-b may be extended from a first time duration to a second time duration when performed within the coordinated time region 625. The first time duration may be associated with the performance of the first channel access procedure at the wireless device 605-b when performed outside of the coordinated time region 625. The second time duration may be longer than the first time duration when the channel access procedure is performed at least partially within the coordinated time region.

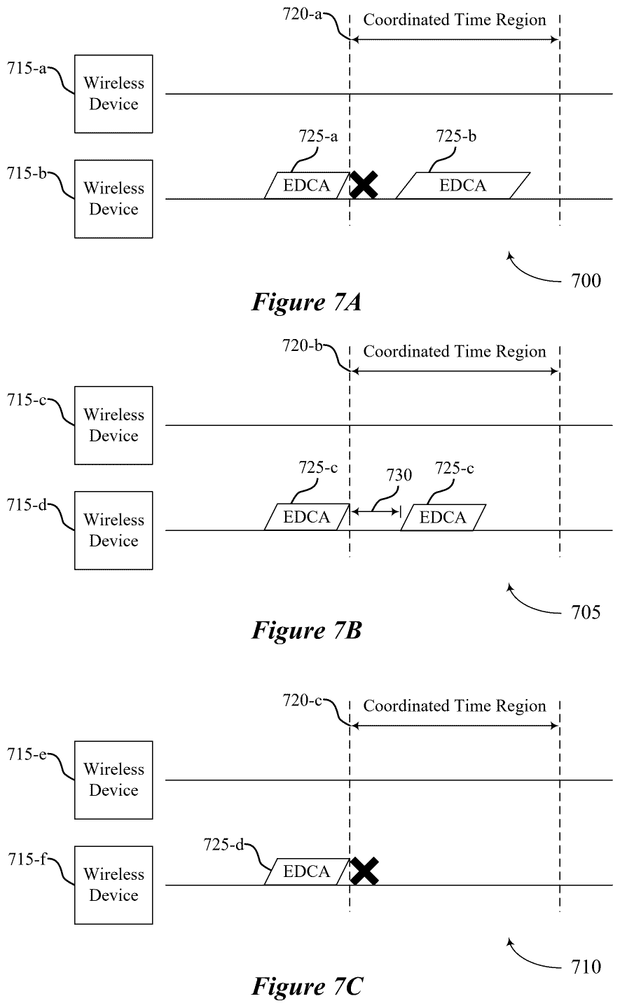

FIGS. 7A, 7B, and 7C show examples of a communications timeline 700, a communications timeline 705, and a communications timeline 710 that supports EDCA rules within CrTWT service periods. In some examples, communications timeline 700, communications timeline 705, or communications timeline 710 may implement aspects of, or be implemented by aspects of, the wireless communication network 100 or the signaling diagram 600. For example, a wireless device 715 may be an example of the wireless device 605-a, the wireless device 605-b, or the wireless device 605-c described with reference to FIG. 2. Multiple wireless devices 715 may communicate in accordance with the communications timeline 700, the communications timeline 705, or the communications timeline 710.

A first wireless device 715 (such as a coordinating AP) may configure a coordinated time region 720-a. A second wireless device 715 (such as an additional AP) may perform EDCA at the boundary of the coordinated time region 720. The second wireless device 715 may communicate in accordance with one or more communications timelines (such as the communications timeline 700 as illustrated in FIG. 7A, the communications timeline 705 as illustrated in FIG. 7B, or the communications timeline 710 as illustrated in FIG. 7C) based on associating the boundary with a virtual channel busy event.

FIG. 7A depicts the communications timeline 700 in which a first wireless device 715-a (such as a coordinating AP) configures a coordinated time region 720-a. A second wireless device 715-b (such as a second AP) may perform an EDCA procedure 725-a at the boundary of the coordinated time region 720-a. The second wireless device 715-b may drop the EDCA procedure 725-a at the boundary of or at the start of the coordinated time region 720-a. The second wireless device 715-b may initiate a second EDCA procedure 725-b after a delay. During an EDCA procedure, a wireless device may contend for access to a shared wireless channel. The result of the EDCA procedure may be that the wireless device wins access to the shared wireless channel and may transmit or receive via the shared wireless channel. Another result of the EDCA procedure may be that the wireless device does not win access to the shared wireless channel and may have to contend for access to the shared wireless channel at a later time (such as after a backoff time duration).

FIG. 7B depicts the communications timeline 705 in which a first wireless device 715-c (such as a coordinating AP) configures a coordinated time region 720-b. A second wireless device 715-d (such as a second AP) may perform an EDCA procedure 725-c at the boundary of the coordinated time region 720-b. The second wireless device 715-b may detect a channel busy event (such as the virtual channel busy event), and the second wireless device 715-d may pause a counter associated with the EDCA procedure 725-c. For example, the second wireless device 715-d may pause the EDCA procedure 725-c for a duration 730. The second wireless device 715-d may resume the EDCA procedure 725-c after detecting a channel free condition (such as [AIFS′[AC]=SIFS+AIFSN′[AC]×9 micro seconds (μs)).

FIG. 7C depicts the communications timeline 710 in which a first wireless device 715-e (such as a coordinating AP) configures a coordinated time region 720-c. A second wireless device 715-f (such as a second AP) may perform EDCA procedure 725-d at the boundary of the coordinated time region 720-c. The second wireless device 715-f may freeze (such as halt) the EDCA procedure 725-d during the coordinated time region 720-c. For example, the second wireless device 715-f may freeze the EDCA procedure 725-d for the entirety of the coordinated time region 720-c, and the second wireless device 715-f may be unable to access a channel associated with the coordinated time region 720-c during the coordinated time region 720-c.

According to techniques described herein, a second wireless device 715 may perform a channel access procedure during the coordinated time region 720. The second wireless device 715 may perform the channel access procedure in accordance with EDCA rules. The EDCA rules may define a length of a time duration associated with the channel access procedure. A delay associated with the channel access procedure may be based on the length of the time duration. For example, the EDCA rules may define an inter frame space or an additional time interval associated with a channel access procedure occurring within a coordinated time region 720. For example, a wireless device 715 may extend the time duration of the channel access procedure via the inter frame space or additional time interval based on performing the channel access procedure within the coordinated time region. The channel access procedure may include the EDCA 725-a, the duration 730, or both.

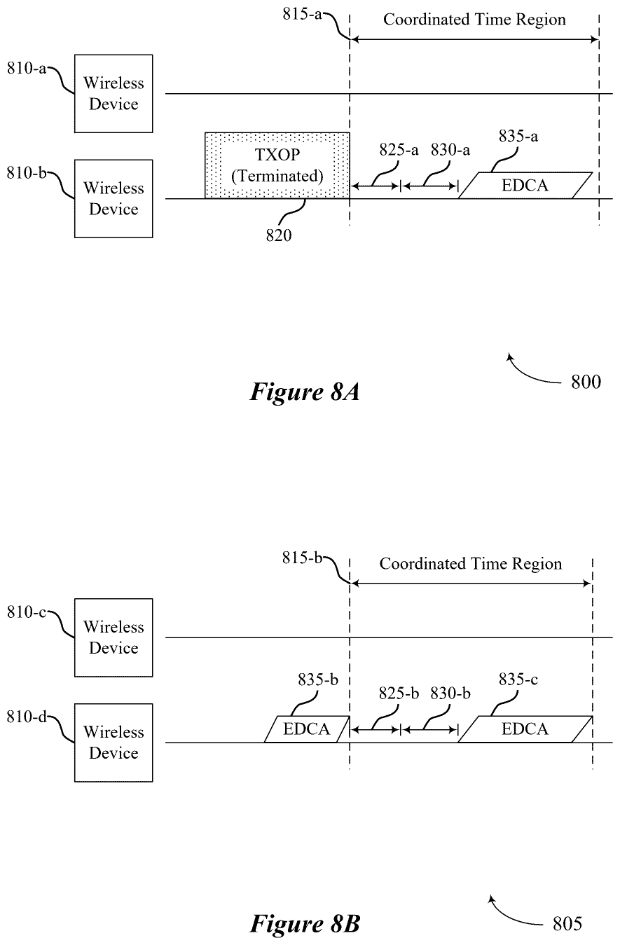

FIGS. 8A and 8B show examples of a communications timeline 800 or a communications timeline 805 that supports EDCA rules within CrTWT service periods. In some examples, communications timeline 800 or communications timeline 805 may implement aspects of, or be implemented by aspects of, the wireless communication network 100 or the signaling diagram 600. For example, a wireless device 810 may be an example of the wireless device 605-a, the wireless device 605-b, or the wireless device 605-c described with reference to FIG. 2. Multiple wireless devices 810 may communicate in accordance with the communications timeline 800 or the communications timeline 805.

A first wireless device 810 (such as a coordinating AP) may configure a coordinated time region 815 of a shared wireless channel. A second wireless device 810 may be associated with traffic, and the second wireless device 810-b may contend for channel access during the coordinated time region 815. The second wireless device 810 may contend for channel access in accordance with EDCA rules. During the coordinated time region 815, the EDCA rules may prioritize latency sensitive traffic associated with the first wireless device 810 over the traffic associated with the second wireless device 810.

For example, EDCA rules may enable the second wireless device 810-b (such as an STA (AP or non-AP)) to contend using an EDCA procedure 835 within a coordinated time region 815. The second wireless device may be configured to detect channel idle conditions for a time duration before continuing with a clear channel assessment. For example, the first wireless device 810 and the second wireless device 810 may contend for access during the coordinated time region 815. The second wireless device may detect, using the EDCA procedure 835, channel idle conditions for an extended time duration compared to the first wireless device 810. For example, the wireless device 810-b may extend the time duration of the channel access procedure based on performing the channel access procedure within the coordinated time region. The extended time duration may delay the second wireless device 810 and prioritize the first wireless device 810. The first wireless device 810 may perform a clear channel assessment prior to the second wireless device 810 based on the extended time duration and delay associated with the second wireless device 810.

In some implementations, the second wireless device 810 may stop a TXOP 820 before or at the boundary of the coordinated time region 815-a and recontend starting at the boundary as illustrated in FIG. 8A. In some implementations, the second wireless device 810 may contend at the boundary, and detect a virtual channel busy event. The second wireless device may pause or restart contention as described with reference to FIGS. 7A-7C.

In some implementations, the second wireless device 810 may perform a channel access procedure (such as a channel access procedure including an EDCA procedure) for a time duration (such as a time duration that includes an inter frame space 825 and a second time duration or additional time interval 830) if the EDCA procedure 835 is performed at the boundary of the coordinated time region (such as the time duration or an additional idle channel time or extended time duration may be applied at the beginning of a coordinated time region 815 (such as a CrTWT service period), and the extended time duration or the additional idle channel time may not be applied for later channel accesses within the coordinated time region 815). For example, the second wireless device 810 may monitor, in the EDCA procedure, conditions of a shared wireless channel for the extended time duration during the coordinated time region if the second wireless device 810 is within a threshold time interval from a beginning boundary of the coordinated time region. If the second wireless device 810 is not within the threshold time interval from the beginning boundary of the coordinated time region (such as the second wireless device 810 is not at the boundary of the coordinated time region 815-a) the second wireless device may not apply the EDCA procedure for the extended time duration. Thus, the second wireless device 810 may monitor for idle conditions of the shared wireless channel for a longer length of time if the EDCA procedure is performed within a threshold time interval from the beginning boundary of the coordinated time region, and may monitor for idle conditions of the shared wireless channel for a shorter length of time if the EDCA procedure is performed after a threshold time interval from the beginning boundary of the coordinated time region. In some implementations, the second wireless device 810 may apply the extended time duration based on TXOP interruption just before the boundary or ongoing EDCA 835 while crossing the boundary of the coordinated time region 815.

In some implementations, the extended time duration may be applied for a threshold quantity of channel accesses (such as N channel accesses) for transmissions within the coordinated time region 815. For example, the second wireless device 810 may apply the EDCA procedure for the extended time duration for a first quantity of channel accesses (such as quantity of EDCA procedures) that satisfy the threshold quantity of channel accesses. For additional channel accesses performed within the coordinated time region 815, the second wireless device 810 may not apply the EDCA procedure for the extended time duration and instead may apply the EDCA procedure for a shorter time duration (such as only monitor channel conditions during the inter frame space 825 but not during the second time duration or addition time interval 830). In some implementations, if the threshold quantity of channel accesses is one (such as N=1), this configuration may be a subcase of EDCA being performed for the time duration within a threshold time interval from the beginning boundary of the coordinated time region 815 discussed herein.

In some implementations, the extended time duration of the EDCA procedure may be may be for each channel access within the coordinated time region 815. For example, the second wireless device 810 may apply the EDCA procedure for the extended time duration for each and every channel access performed within the coordinated time region 815.

The extended time duration (such as the interval over the channel which is to be detected to be idle for a clear channel assessment) may include at least one of an inter frame space 825 and a second time duration or additional time interval 830. For example, a wireless device 810 may extend a time duration associated with the channel access procedure based on performing the channel access procedure within the coordinated time region 815. A duration in time associated with the inter frame space 825 or the additional time interval 830 may be based on the second wireless device 810 performing a channel access procedure within the coordinated time region 815. In some examples, the channel access procedure may include an inter frame space 825-a, an additional time interval 830-a, an EDCA 835-a, or an combination thereof, as shown in FIG. 8A. In some examples, the channel access procedure may include an EDCA 835-b, an inter frame space 825-b, an additional time interval 830-b, an EDCA 836-c, or any combination thereof, as shown in FIG. 8B. The parameters of an EDCA 835-a may be based on the second wireless device 810-b contending for the channel during the coordinated time region 815-a. For example, the parameters of the EDCA 835 may be EDCA parameters for a contending wireless device 810 (such as a contending STA). The inter frame space 825 or the additional time interval 830 may be a set of one or more backoff slots (such as one or more 9 μs backoff slots).

In some implementations, the duration in time of the inter frame space 825 may be determined based on a predefined AC of traffic associated with the second wireless device 810. A duration associated with the inter frame space 825 may be based on the predefined AC. For example, the second wireless device 810 may detect an arbitration inter-frame spacing (AIFS) of the predefined AC (such as AIFS[AC*] where AC* may be specified). For example, the predefined AC may be an example of a best effort AC. During the coordinated time region 815, the second wireless device 810 may detect an AIFS for best effort traffic (such as best effort (BE)→AIFS[BE]).

In some implementations, the duration in time of the inter frame space 825 may be determined based on the channel access parameters and the AC of the traffic for which the channel access is performed (such as a AC associated with the second wireless device 810 or an accessing STA). The channel access parameters may include a potential window size, a minimum contention window size, a maximum contention window size, or an arbitration inter frame space number (AIFSN). For example, the second wireless device 810 may detect an AIFS associated with an AIFSN corresponding to the AC of the traffic. (such as AIFS[AIFSN[AC]]). The AC may be associated with buffered data for which channel access is being performed. A first AC may be associated with the first wireless device 810 (such as the coordinating AP), and a second AC may be associated with the second wireless device 810 (such as an STA). The EDCA rules may implement prioritization of the first wireless device 810 or the second wireless device 810 (such as an STA performing channel access for voice traffic may wait less time than a coordinating AP accessing for best effort traffic).

The duration in time of the additional time interval 830 may be determined based on the second AC of the second wireless device 810 (such as the contending STA). For example, the EDCA rules may implement prioritization of the second wireless device 810 or the first wireless device 810 based on the first AC or the second AC (such as an STA performing channel access for voice traffic may wait less time than a coordinating AP accessing for best effort traffic). In some implementations, the additional time interval 830 may be preconfigured or predefined at the first wireless device 810 and the second wireless device 810. For example, the EDCA rules may include a delay (such as a blanket penalty) for all wireless device 810 (such as STAs) that are not the first wireless device (such as the coordinating AP). In some implementations, the additional time interval 830 may be determined based on the AC associated with a traffic identifier (TID) flows of the first wireless device 810 (such as the coordinating AP setting up the coordinated time region 815). For example, (such as if a coordinated time region 815 is a CrTWT service period), the first wireless device may include information about traffic flows for that CrTWT service period and one or more ACs associated with the traffic flows via a broadcast TWT.

The second wireless device 810 may perform a channel access procedure for the shared wireless channel over a time duration that occurs within the coordinated time region, where a length of the time duration may be extended based on the channel access procedure being performed within the coordinated time region. The length of the time duration may include an inter frame space 825, the additional time interval 830, or an additional time duration.

In some implementations, the second wireless device 810 may be an example of an AP. The second wireless device 810 may manage an independent BSS for uplink traffic (such as transmissions from one or more STAs associated with the second wireless device 810) via mechanisms such as multi-user EDCA or a request to send (RTS) enablement. In some implementations, the second wireless device 810 may manage the independent BSS based on an associated wireless device (such as a non-AP) sending an RTS prior to any single user uplink transmission. The associated wireless device may send uplink traffic based on the AP (such as second wireless device 810) responding to the RTS with a clear to send (CTS) message.

FIG. 8A depicts the communications timeline 800 in which, a first wireless device 810-a (such as a coordinating AP) configures a coordinated time region 815-a. The second wireless device 810-b may perform a TXOP 820 prior to the coordinated time region 815-a. The second wireless device 810-b may terminate the TXOP 820 prior to the boundary of the coordinated time region 815-a or at the boundary of the coordinated time region 815-a. The second wireless device 810-b may contend for channel access, using an EDCA procedure, during the coordinated time region 815-a. In some implementations, the second wireless device 810-b may apply the extended time duration during a clear channel assessment. For example, the second wireless device 810-b may detect channel conditions during an extended time duration. The extended time duration may include an inter frame space 825-a and an additional time interval 830-a. The second wireless device 810-b may perform EDCA procedure 835-a after the extended time duration has elapsed (such as after inter frame space 825-a and an additional time interval 830-a), to provide the first wireless device 810-a to contend for access to the shared wireless channel during the coordinated time region 815-a prior to the second wireless device 810-b. Thus providing the opportunity for earlier access to the coordinated time region 815-a by the first wireless device 810-a, but also permitting the second wireless device 810-b to attempt to access the shared wireless channel during the coordinated time region 815-a should the first wireless device 810-a not need to transmit during the coordinated time region 815-a.

FIG. 8B depicts the communications timeline 805 in which, a first wireless device 810-c (such as a coordinating AP) configures a coordinated time region 815-b. The second wireless device 810-d may perform a EDCA 835-b prior to the coordinated time region 815-b. The second wireless device 810-d may pause or terminate (such as described with reference to FIGS. 7A-7C) the EDCA 835-b prior to the boundary of the coordinated time region 815-b or at the boundary of the coordinated time region 815-b. The second wireless device 810-d may contend for channel access during the coordinated time region 815-b. In some implementations, the second wireless device 810-d may apply the clear channel assessment for an extended time duration. For example, the second wireless device 810-b may detect channel conditions during the extended time duration. The extended time duration may include an inter frame space 825-b and an additional time interval 830-b. The second wireless device 810-d may perform EDCA 835-c after the extended time duration.

The wireless device 810-b and the wireless device 810-d may contend for the same shared wireless channel (such as the coordinated time region 815-a may be the same coordinated time region as 815-b). In some examples, the wireless device 810-b and the wireless device 810-d may be associated with the same delay (such as a penalty) when entering the coordinated time region. For example, the wireless device 810-b and the wireless device 810-d may be associated with the same extended time duration or delay (such as the same length of the extended time duration). The wireless device 810-b may interrupt or terminate the TXOP 820. The wireless device 810-b may initialize a new counter for the EDCA 835-a. The wireless device 810-d may be contending for the shared wireless channel prior to a coordinated time region 815. For example, the wireless device 810-d may have a smaller random counter value at the boundary of the coordinated time region 815 compared to the wireless device 810-b based on the wireless device 810-d contending prior to the coordinated time region 815. In some examples, the wireless device 810-d may pause the random counter associated with the EDCA 835-b for the inter frame space 825-b and the additional time interval 830-b, as described with reference to FIG. 7B. The wireless device 810-b may be disadvantaged based on the wireless device 810-d being associated with a smaller random counter value. For example, the new random counter associated with the wireless device 810-b may (such as on average) be larger than the random counter associated with the wireless device 810-d that ran prior to the coordinated time region 815.

In some examples, the delay when entering the coordinated time region associated with the wireless device 810-b and the wireless device 810-d may not be the same delay. For example, the delay associated with the wireless device 810-d may be longer than the delay associated with the wireless device 810-b. For example, the EDCA rules may be designed, with smaller delays for the wireless device 810-d. The wireless device 810-b and the wireless device 810-d may be associated with two separate sets of delays based on terminating a TXOP 820 prior to a coordinated time region 815 or pausing a EDCA 835 prior to a coordinated time region. For example, the EDCA rules may define an additional time interval 830 or a set of additional time intervals 830, for a given AC. Additionally, or alternatively, the EDCA 835 rules may define an additional time interval 830 or a set of additional time intervals 830 based on whether a wireless device 810 terminated a TXOP 820 or a EDCA 835 prior to the coordinated time region 815.

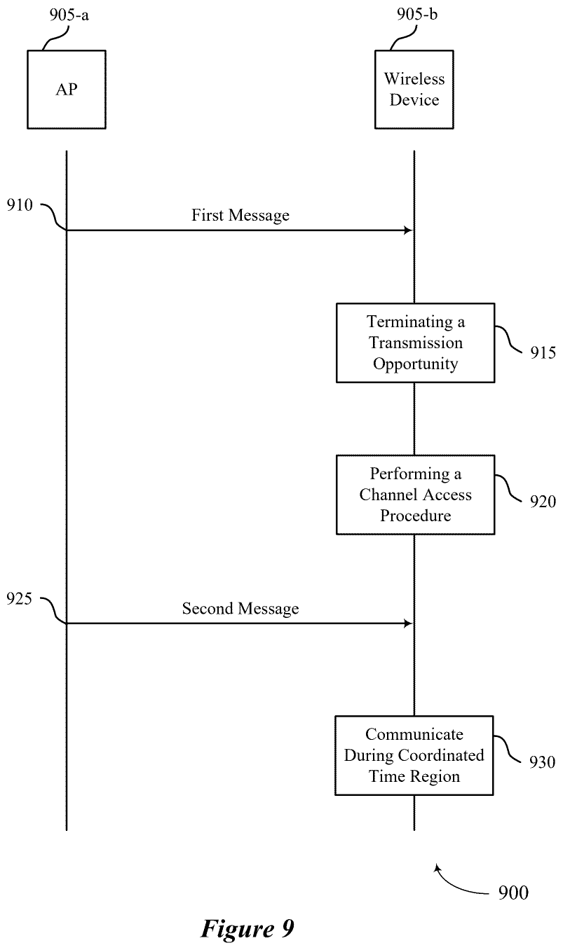

FIG. 9 shows an example of a process flow 900 that supports EDCA rules within CrTWT service periods. In some examples, process flow 900 may implement aspects of, or be implemented by aspects of, the wireless communication network 100 or the signaling diagram 600. For example, a wireless device 810 may be an example of the wireless device 605-a, the wireless device 605-b, or the wireless device 605-c described with reference to FIG. 2. For example, the process flow 900 may include a first AP 905-a (such as a wireless device) and a wireless device 905-b (such as an STA) which may be examples of corresponding devices described with reference to FIGS. 1-8B.

The first AP 905-a may negotiate with the wireless device 905-b to determine a coordinated time region, as described in FIG. 6.

At 910, the wireless device 905-b may obtain (such as receive via wireless transmission) a first message indicating a coordinated time region associated with a first AP. The first message may request prioritized access for the first AP to a shared wireless channel during the coordinated time region.

In some implementations, at 915, the wireless device 905-b may terminate a TXOP prior to a start time of the coordinated time region. The channel access procedure may initiated at or after the start time of the coordinated time region. For example, the wireless device 905-b may terminate a TXOP prior to or at the boundary of a coordinated time region, as described in FIG. 6. In some implementations, the length of the time duration may be extended based on terminating the TXOP prior to a start time of the coordinated time region.

The wireless device 905-b may initiate the channel access procedure prior to a start time of the coordinated time region. In some examples, the channel access procedure may paused or terminated at or before the start time of the coordinated time region. In some examples, the channel access procedure may be restarted at or after the start time of the coordinated time region. In some examples, the length of the time duration may be extended based on initiating the channel access procedure prior to the start time of the coordinated time region.

At 920, the wireless device 905-b may perform a channel access procedure for the shared wireless channel over a time duration that occurs within the coordinated time region. A length of the time duration may be extended based on the channel access procedure being performed within the coordinated time region. For example, the length of the time duration may delay the channel access procedure associated with the wireless device 905-b, which may prioritize a channel access procedure associated with the AP 905-a.

In some implementations, the wireless device 905-b may perform the channel access procedure over the length of the time duration based on the channel access procedure being initiated within a threshold time window after a start time of the coordinated time region. In some implementations, perform the channel access procedure over the length of the time duration based on a quantity of channel access procedures performed after a start time of the coordinated time region being less than a threshold quantity.

In some implementations, the length of the time duration may include an inter frame space, an additional time interval, or both, as described with reference to FIGS. 8A and 8B. The inter frame space may be based on a delay associated with an AC. For example, the inter frame space may be based on an AC associated with the wireless device 905-b. The inter frame space may be based on a channel access parameter, a delay associated with an AC of traffic, or both.

In some implementations, the additional time interval may be based on an AC associated with the wireless device 905-b. In some examples, the additional time interval may be a predefined time duration. In some examples, the additional time interval may be based on an AC associated with a TID flow of the first AP. In some examples, the additional time interval may be associated with a quantity of one or more backoff slots.

In some implementations, at 925, the wireless device 905-b may obtain a second message, via broadcast target wake time signaling, indicating the AC associated with the TID flow. In some examples, the first message may indicate the AC associated with the TID flow.

At 930, the wireless device 905-b may communicate with one or more wireless devices 905 via the shared wireless channel. In some implementations, the wireless device 905-b may communicate with the one or more wireless device 905 during the coordinated time region.

In some implementations, the coordinated time region may be a CrTWT period. In some implementations, the wireless device 905-b may be a second AP that coordinates with the first AP (such as a second AP within the neighborhood of the first AP). In some implementations, the wireless device 905-b may be associated with the first AP or a second AP that coordinates with of the first AP. For example, the wireless device 905-b may be an example of an STA served by the first AP or the second AP in the neighborhood of the first AP.

In some implementations, the wireless device 905-b may manage traffic, at the second AP, via a multi-user enhanced distributed channel access or a request to send enablement.

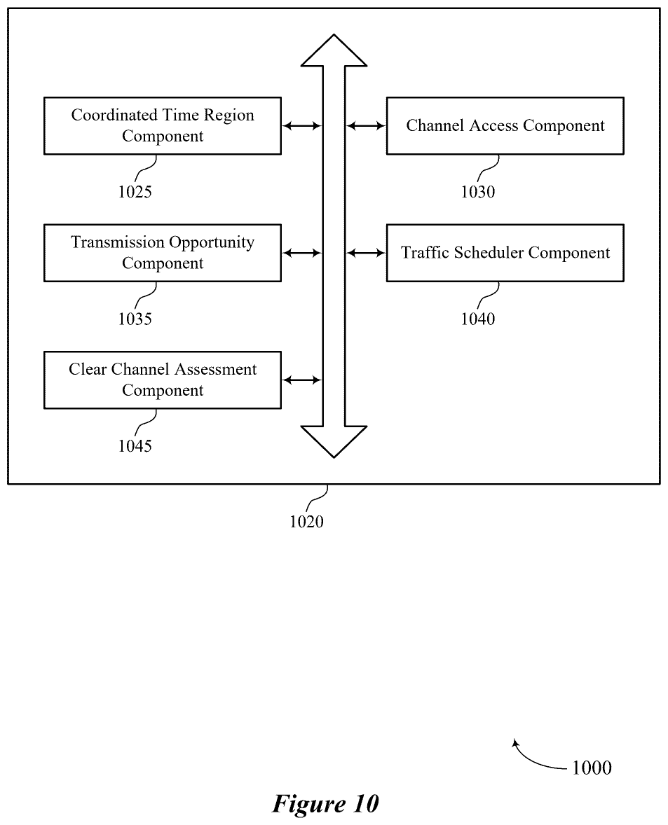

FIG. 10 shows a block diagram 1000 of a wireless device 1020 that supports EDCA rules within CrTWT service periods. The wireless device 1020 may be an example of aspects of a wireless device as described with reference to FIGS. 2 through 9. The wireless device 1020, or various components thereof, may be an example of means for performing various aspects of EDCA rules within CrTWT service periods as described herein. For example, the wireless device 1020 may include a coordinated time region component 1025, a channel access component 1030, a TXOP component 1035, a traffic scheduler component 1040, a clear channel assessment component 1045, or any combination thereof. Each of these components, or components or subcomponents thereof (such as one or more processors, one or more memories), may communicate, directly or indirectly, with one another (such as via one or more buses).

The wireless communication device 1020 may support wireless communications in accordance with examples as disclosed herein. The coordinated time region component 1025 is configurable or configured to obtain a first message indicating a coordinated time region associated with a first AP, the first message requesting prioritized access for the first AP to a shared wireless channel during the coordinated time region. The channel access component 1030 is configurable or configured to perform a channel access procedure for the shared wireless channel over a time duration that occurs within the coordinated time region, where a length of the time duration may be extended based at least in part on the channel access procedure being performed within the coordinated time region.

In some examples, the TXOP component 1035 is configurable or configured to terminate a TXOP prior to a start time of the coordinated time region, where the channel access procedure is initiated at or after the start time of the coordinated time region.

In some examples, to support performing the channel access procedure, the channel access component 1030 is configurable or configured to initiate the channel access procedure prior to a start time of the coordinated time region, where the channel access procedure is paused or terminated at or before the start time of the coordinated time region.

In some examples, to support performing the channel access procedure, the channel access component 1030 is configurable or configured to initiate the channel access procedure prior a start time of the coordinated time region, where the channel access procedure is restarted at or after the start time of the coordinated time region.

In some examples, to support performing the channel access procedure, the channel access component 1030 is configurable or configured to perform the channel access procedure over the length of the time duration based on the channel access procedure being initiated within a threshold time window after a start time of the coordinated time region.

In some examples, to support performing the channel access procedure, the channel access component 1030 is configurable or configured to perform the channel access procedure over the length of the time duration based on a quantity of channel access procedures performed after a start time of the coordinated time region being less than a threshold quantity. In some examples, to perform a channel access procedure, the channel access component 1030 is configurable or configured to monitor for channel idle conditions for the length of the time duration that is extended based at least in part on the channel access procedure being performed within the coordinated time region.

In some examples, the length of the time duration is extended based at least in part on terminating the TXOP prior to a start time of the coordinated time region.

In some examples, the length of the time duration is extended based at least in part on initiating the channel access procedure prior to the start time of the coordinated time region.

In some examples, the length of the time duration includes an inter frame space, an additional time interval for monitoring for channel idle conditions, or both.

In some examples, the inter frame space is based on a delay associated with an AC.

In some examples, the inter frame space is based on a channel access parameter, a delay associated with an AC of traffic, or both.

In some examples, the additional time interval is based on an AC associated with the wireless device.

In some examples, the additional time interval is a predefined time duration.

In some examples, the additional time interval is associated with a quantity of one or more backoff slots.

In some examples, the additional time interval is based on an AC associated with a TID flow of the first AP.

In some examples, the clear channel assessment component 1045 is configurable or configured to obtain a second message, via broadcast target wake time signaling, indicating the AC associated with the TID flow.

In some examples, the second message is obtained via the first message.

In some examples, the coordinated time region is a CrTWT period.

In some examples, the wireless device is a second AP that coordinates with the first AP.

In some examples, the traffic scheduler component 1040 is configurable or configured to manage traffic, at the second AP, via a multi-user enhanced distributed channel access or a request to send enablement.

In some examples, the wireless device is associated with the first AP or a second AP that coordinates with the first AP.

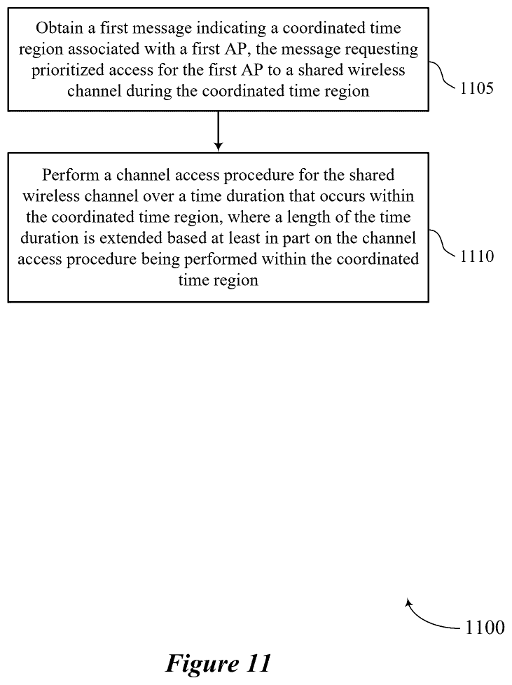

FIG. 11 shows a flowchart illustrating a method 1100 that supports EDCA rules within CrTWT service periods. The operations of the method 1100 may be implemented by a wireless device or its components as described herein. For example, the operations of the method 1100 may be performed by a wireless device as described with reference to FIGS. 2 through 10. In some examples, a wireless device may execute a set of instructions to control the functional elements of the wireless device to perform the described functions. Additionally, or alternatively, the wireless device may perform aspects of the described functions using special-purpose hardware.

At 1105, the method may include obtaining a first message indicating a coordinated time region associated with a first AP, the first message requesting prioritized access for the first AP to a shared wireless channel during the coordinated time region. The operations of 1105 may be performed in accordance with examples as disclosed herein. In some examples, aspects of the operations of 1105 may be performed by a coordinated time region component 1025 as described with reference to FIG. 10.

At 1110, the method may include performing a channel access procedure for the shared wireless channel over a time duration that occurs within the coordinated time region, wherein a length of the time duration is extended based at least in part on the channel access procedure being performed within the coordinated time region. The operations of 1110 may be performed in accordance with examples as disclosed herein. In some examples, aspects of the operations of 1110 may be performed by a channel access component 1030 as described with reference to FIG. 10.

Implementation examples are described in the following numbered clauses:

Aspect 1: A method by a wireless device, comprising: obtaining a first message indicating a coordinated time region associated with a first AP, the first message requesting prioritized access for the first AP to a shared wireless channel during the coordinated time region; and performing a channel access procedure for the shared wireless channel over a time duration that occurs within the coordinated time region, wherein the time duration comprises a length of the time duration, the length of the time duration being based at least in part on the time duration being within the coordinated time region.

Aspect 2: The method of aspect 1, further comprising: terminating a TXOP prior to a start time of the coordinated time region, wherein the channel access procedure is initiated at or after the start time of the coordinated time region.

Aspect 3: The method of aspect 2, wherein the length of the time duration is extended based at least in part on terminating the TXOP prior to a start time of the coordinated time region.

Aspect 4: The method of aspect 1, wherein performing the channel access procedure comprises: initiating the channel access procedure prior to a start time of the coordinated time region, wherein the channel access procedure is paused or terminated at or before the start time of the coordinated time region.

Aspect 5: The method of aspect 4, wherein the length of the time duration is extended based at least in part on initiating the channel access procedure prior to the start time of the coordinated time region.

Aspect 6: The method of any of aspects 1 through 5, wherein performing the channel access procedure comprises: initiating the channel access procedure prior a start time of the coordinated time region, wherein the channel access procedure is restarted at or after the start time of the coordinated time region.

Aspect 7: The method of any of aspects 1 through 6, wherein performing the channel access procedure comprises: performing the channel access procedure over the length of the time duration based at least in part on the channel access procedure being initiated within a threshold time window after a start time of the coordinated time region.

Aspect 8: The method of any of aspects 1 through 7, wherein performing the channel access procedure comprises: performing the channel access procedure over the length of the time duration based at least in part on a quantity of channel access procedures performed after a start time of the coordinated time region being less than a threshold quantity.

Aspect 9: The method of any of aspects 1 through 8, wherein the length of the time duration includes an inter frame space, an additional time interval, or both.

Aspect 10: The method of aspect 9, wherein the inter frame space is based at least in part on a delay associated with an AC.

Aspect 11: The method of any of aspects 9 through 10, wherein the inter frame space is based at least in part on a channel access parameter, a delay associated with an AC of traffic, or both.

Aspect 12: The method of any of aspects 9 through 11, wherein the additional time interval is based at least in part on an AC associated with the wireless device.

Aspect 13: The method of any of aspects 9 through 11, wherein the additional time interval is a predefined time duration or is associated with a quantity of one or more backoff slots.

Aspect 14: The method of any of aspects 9 through 12, wherein performing the channel access procedure comprises monitoring for channel idle conditions for the length of the time duration that is extended based at least in part on the channel access procedure being performed within the coordinated time region.

Aspect 15: The method of any of aspects 9 through 14, wherein the additional time interval is based at least in part on an AC associated with a TID of the first AP.

Aspect 16: The method of aspect 15, further comprising: obtaining a second message, via broadcast target wake time signaling, indicating the AC associated with the TID.

Aspect 17: The method of any of aspects 15 through 16, wherein the first message indicates the AC associated with the TID.

Aspect 18: The method of any of aspects 1 through 17, wherein the coordinated time region is a CrTWT period.

Aspect 19: The method of any of aspects 1 through 18, wherein the wireless device is a second AP that coordinates with the first AP.

Aspect 20: The method of aspect 19, further comprising: managing traffic, at the second AP, via a multi-user enhanced distributed channel access or a request to send enablement.

Aspect 21: The method of any of aspects 1 through 18, wherein the wireless device is associated with the first AP or a second AP that coordinates with the first AP.

Aspect 22: A wireless device comprising one or more memories storing processor-executable code, and one or more processors coupled with the one or more memories and individually or collectively operable to execute the code to cause the wireless device to perform a method of any of aspects 1 through 21.

Aspect 23: A wireless device comprising at least one means for performing a method of any of aspects 1 through 21.

Aspect 24: A non-transitory computer-readable medium storing code the code comprising instructions executable by one or more processors to perform a method of any of aspects 1 through 21.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,”” or the equivalent in context, whatever it is that is “based on ‘a,” or “based at least in part on ‘a,” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

What is claimed is:

1. A wireless device, comprising:
a processing system that includes processor circuitry and memory circuitry that stores code, the processing system configured to cause the wireless device to:
obtain a first message indicating a coordinated time region associated with a first access point (AP), the first message requesting prioritized access for the first AP to a shared wireless channel during the coordinated time region; and
perform a channel access procedure for the shared wireless channel over a time duration that occurs within the coordinated time region, wherein a length of the time duration is extended based at least in part on the channel access procedure being performed within the coordinated time region.

2. The wireless device of claim 1, wherein the processing system is further configured to cause the wireless device to:
terminate a transmission opportunity prior to a start time of the coordinated time region, wherein the channel access procedure is initiated at or after the start time of the coordinated time region.

3. The wireless device of claim 2, wherein the length of the time duration is extended based at least in part on termination of the transmission opportunity prior to a start time of the coordinated time region.

4. The wireless device of claim 1, wherein, to perform the channel access procedure, the processing system is configured to cause the wireless device to:
initiate the channel access procedure prior to a start time of the coordinated time region, wherein the channel access procedure is paused or terminated at or before the start time of the coordinated time region.

5. The wireless device of claim 4, wherein the length of the time duration is extended based at least in part on initiation of the channel access procedure prior to the start time of the coordinated time region.

6. The wireless device of claim 1, wherein, to perform the channel access procedure, the processing system is configured to cause the wireless device to:
initiate the channel access procedure prior a start time of the coordinated time region, wherein the channel access procedure is restarted at or after the start time of the coordinated time region.

7. The wireless device of claim 1, wherein, to perform the channel access procedure, the processing system is configured to cause the wireless device to:
perform the channel access procedure over the length of the time duration based at least in part on the channel access procedure being initiated within a threshold time window after a start time of the coordinated time region.

8. The wireless device of claim 1, wherein, to perform the channel access procedure, the processing system is configured to cause the wireless device to:
perform the channel access procedure over the length of the time duration based at least in part on a quantity of channel access procedures performed after a start time of the coordinated time region being less than a threshold quantity.

9. The wireless device of claim 1, wherein the time duration includes an inter frame space, an additional time interval for monitoring for channel idle conditions, or both.

10. The wireless device of claim 9, wherein the inter frame space is based at least in part on a delay associated with an access category.

11. The wireless device of claim 9, wherein the inter frame space is based at least in part on a channel access parameter, a delay associated with an access category of traffic, or both.

12. The wireless device of claim 9, wherein the additional time interval is based at least in part on an access category associated with the wireless device.

13. The wireless device of claim 9, wherein the additional time interval is a predefined time duration or is associated with a quantity of one or more backoff slots.

14. The wireless device of claim 9, wherein, to perform the channel access procedure, the processing system is further configured to cause the wireless device to:
monitor the shared wireless channel for channel idle conditions for the length of the time duration that is extended based at least in part on the channel access procedure being performed within the coordinated time region.

15. The wireless device of claim 9, wherein the additional time interval is based at least in part on an access category associated with a traffic identifier flow of the first AP.

16. The wireless device of claim 15, wherein the processing system is further configured to cause the wireless device to:
obtain a second message, via broadcast target wake time signaling, indicating the access category associated with the traffic identifier flow.

17. The wireless device of claim 15, wherein the first message indicates the access category associated with the traffic identifier flow.

18. The wireless device of claim 1, wherein the coordinated time region is a coordinated restricted target wake time period.

19. The wireless device of claim 1, wherein the wireless device is a second AP that coordinates with the first AP.

20. The wireless device of claim 19, wherein the processing system is further configured to cause the wireless device to:
manage traffic, at the second AP, via a multi-user enhanced distributed channel access or a request to send enablement.

21. The wireless device of claim 1, wherein the wireless device is associated with the first AP or a second AP that coordinates with the first AP.

22. A method for wireless communications at a wireless device, comprising:
obtaining a first message indicating a coordinated time region associated with a first access point (AP), the first message requesting prioritized access for the first AP to a shared wireless channel during the coordinated time region; and
performing a channel access procedure for the shared wireless channel over a time duration that occurs within the coordinated time region, wherein a length of the time duration is extended based at least in part on the channel access procedure being performed within the coordinated time region.

23. The method of claim 22, further comprising:
terminating a transmission opportunity prior to a start time of the coordinated time region, wherein the channel access procedure is initiated at or after the start time of the coordinated time region.

24. The method of claim 22, wherein performing the channel access procedure comprises:
initiating the channel access procedure prior to a start time of the coordinated time region, wherein the channel access procedure is paused or terminated at or before the start time of the coordinated time region.

25. The method of claim 22, wherein performing the channel access procedure comprises:
initiating the channel access procedure prior a start time of the coordinated time region, wherein the channel access procedure is restarted at or after the start time of the coordinated time region.

26. The method of claim 22, wherein performing the channel access procedure comprises:
performing the channel access procedure over the length of the time duration based at least in part on the channel access procedure being initiated within a threshold time window after a start time of the coordinated time region.

27. The method of claim 22, wherein performing the channel access procedure comprises:
performing the channel access procedure over the length of the time duration based at least in part on a quantity of channel access procedures performed after a start time of the coordinated time region being less than a threshold quantity.

28. The method of claim 22, wherein the time duration includes an inter frame space, an offset, or both.

29. A non-transitory computer-readable medium storing code for wireless communications, the code comprising instructions executable by one or more processors to:
obtain a first message indicating a coordinated time region associated with a first access point (AP), the first message requesting prioritized access for the first AP to a shared wireless channel during the coordinated time region; and
perform a channel access procedure for the shared wireless channel over a time duration that occurs within the coordinated time region, wherein a length of the time duration is extended based at least in part on the channel access procedure being performed within the coordinated time region.

30. A wireless device for wireless communications, comprising:
means for obtaining a first message indicating a coordinated time region associated with a first access point (AP), the first message requesting prioritized access for the first AP to a shared wireless channel during the coordinated time region; and
means for performing a channel access procedure for the shared wireless channel over a time duration that occurs within the coordinated time region, wherein a length of the time duration is extended based at least in part on the channel access procedure being performed within the coordinated time region.
